(19) United States
(12) Patent Application Publication
(10) Pub. No.: US 2016/0284204 A1
(43) Pub. Date: Sep. 29, 2016

(54) ALARM APPARATUS WITH SHORT DISTANCE WIRELESS COMMUNICATION FUNCTION

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 14/667,786

(22) Filed: Mar. 25, 2015

(51) Int. Cl. G08B 25/10; G08B 3/10

(52) U.S. Cl. CPC G08B 25/10; G08B 3/10

(57) ABSTRACT

An alarm apparatus is applied to a portable wireless communication apparatus. The alarm apparatus includes an alarm unit and a short distance wireless communication unit. The short distance wireless communication unit is electrically connected to the alarm unit. The portable wireless communication apparatus transmits a present time setting signal to the short distance wireless communication unit. The short distance wireless communication unit transmits the present time setting signal to the alarm unit after the short distance wireless communication unit receives the present time setting signal. The alarm unit sets a present time according to the present time setting signal after the alarm unit receives the present time setting signal.

### BACKGROUND OF THE INVENTION

1. Field of the Invention

The present invention relates to an alarm apparatus, and especially relates to an alarm apparatus with a short distance wireless communication function.

2. Description of the Related Art

The alarm is a very common household appliance. Almost every family has alarms. People rely on alarms to awaken them at specific times.

The alarm is popular but setting the alarm is inconvenient, such as setting the present time of the alarm, the alarm time of the alarm, the alarm sound pattern of the alarm, the alarm sound volume of the alarm, the backlight color of the display of the alarm, and the backlight brightness of the display of the alarm. Usually, the user has to press the buttons of the alarm to set the functions mentioned above. It is very inconvenient.

### SUMMARY OF THE INVENTION

In order to solve the above-mentioned problems, an object of the present invention is to provide an alarm apparatus with a short distance wireless communication function.

In order to achieve the object of the present invention mentioned above, the alarm apparatus is applied to a portable wireless communication apparatus. The alarm apparatus comprises an alarm unit and a short distance wireless communication unit. The short distance wireless communication unit is electrically connected to the alarm unit. The portable wireless communication apparatus transmits a present time setting signal to the short distance wireless communication unit. The short distance wireless communication unit transmits the present time setting signal to the alarm unit after the short distance wireless communication unit receives the present time setting signal. The alarm unit sets a present time according to the present time setting signal after the alarm unit receives the present time setting signal.

Moreover, the alarm unit comprises a microprocessor electrically connected to the short distance wireless communication unit. The short distance wireless communication unit transmits the present time setting signal to the microprocessor after the short distance wireless communication unit receives the present time setting signal. The microprocessor sets the present time according to the present time setting signal after the microprocessor receives the present time setting signal.

Moreover, the alarm unit further comprises a speaker electrically connected to the microprocessor. The portable wireless communication apparatus transmits an alarm time setting signal to the short distance wireless communication unit. The short distance wireless communication unit transmits the alarm time setting signal to the microprocessor after the short distance wireless communication unit receives the alarm time setting signal. The microprocessor sets an alarm time according to the alarm time setting signal after the microprocessor receives the alarm time setting signal. The microprocessor is configured to drive the speaker to play an alarm sound when the alarm time is equal to the present time. The portable wireless communication apparatus transmits an alarm sound pattern setting signal to the short distance wireless communication unit. The short distance wireless communication unit transmits the alarm sound pattern setting signal to the microprocessor after the short distance wireless communication unit receives the alarm sound pattern setting signal. The microprocessor sets a pattern of the alarm sound according to the alarm sound pattern setting signal after the microprocessor receives the alarm sound pattern setting signal. The portable wireless communication apparatus transmits an alarm sound volume setting signal to the short distance wireless communication unit. The short distance wireless communication unit transmits the alarm sound volume setting signal to the microprocessor after the short distance wireless communication unit receives the alarm sound volume setting signal. The microprocessor sets a volume of the alarm sound according to the alarm sound volume setting signal after the microprocessor receives the alarm sound volume setting signal.

Moreover, the alarm unit further comprises a display electrically connected to the microprocessor. The microprocessor is configured to drive the display to display the present time and the alarm time.

Moreover, the alarm unit further comprises a display backlight module electrically connected to the microprocessor. The portable wireless communication apparatus transmits a backlight color setting signal to the short distance wireless communication unit. The short distance wireless communication unit transmits the backlight color setting signal to the microprocessor after the short distance wireless communication unit receives the backlight color setting signal. The microprocessor sets a backlight color of the display backlight module according to the backlight color setting signal after the microprocessor receives the backlight color setting signal. The portable wireless communication apparatus transmits a backlight brightness setting signal to the short distance wireless communication unit. The short distance wireless communication unit transmits the backlight brightness setting signal to the microprocessor after the short distance wireless communication unit receives the backlight brightness setting signal. The microprocessor sets a backlight brightness of the display backlight module according to the backlight brightness setting signal after the microprocessor receives the backlight brightness setting signal.

Moreover, the alarm apparatus further comprises a wireless charging module electrically connected to the microprocessor. The wireless charging module wirelessly charges the portable wireless communication apparatus.

Moreover, the alarm apparatus further comprises an electroencephalogram signal processing module electrically connected to the microprocessor. The electroencephalogram signal processing module transmits an electroencephalogram signal to the microprocessor. The microprocessor transmits the electroencephalogram signal to the short distance wireless communication unit after the microprocessor receives the electroencephalogram signal. The short distance wireless communication unit transmits the electroencephalogram signal to the portable wireless communication apparatus after the short distance wireless communication unit receives the electroencephalogram signal.

Moreover, the short distance wireless communication unit comprises an antenna and a short distance wireless communication interface circuit. The short distance wireless communication interface circuit is electrically connected to the antenna.

Moreover, the short distance wireless communication unit further comprises a current-to-voltage converting circuit and a voltage regulation circuit. The current-to-voltage converting circuit is electrically connected to the short distance wireless communication interface circuit. The voltage regulation circuit is electrically connected to the current-to-voltage converting circuit.

Moreover, the short distance wireless communication unit further comprises a memory unit and a wire communication interface circuit. The memory unit is electrically connected to the short distance wireless communication interface circuit and the voltage regulation circuit. The wire communication interface circuit is electrically connected to the memory unit and the microprocessor.

The present invention comprises following advantages.

1. The present invention can wirelessly set the present time of the alarm, the alarm time of the alarm, the alarm sound pattern of the alarm, the alarm sound volume of the alarm, the backlight color of the display of the alarm, and the backlight brightness of the display of the alarm.

2. The present invention can wirelessly charge the portable wireless communication apparatus.

3. The present invention can be applied to the electroencephalogram.

### BRIEF DESCRIPTION OF DRAWING

FIG. 1 shows a block diagram of the alarm apparatus of the present invention.

FIG. 2 shows a block diagram of the short distance wireless communication unit of the present invention.

### DETAILED DESCRIPTION OF THE INVENTION

Please refer to following detailed description and figures for the technical content of the present invention. The following detailed description and figures are referred for the present invention, but the present invention is not limited to it.

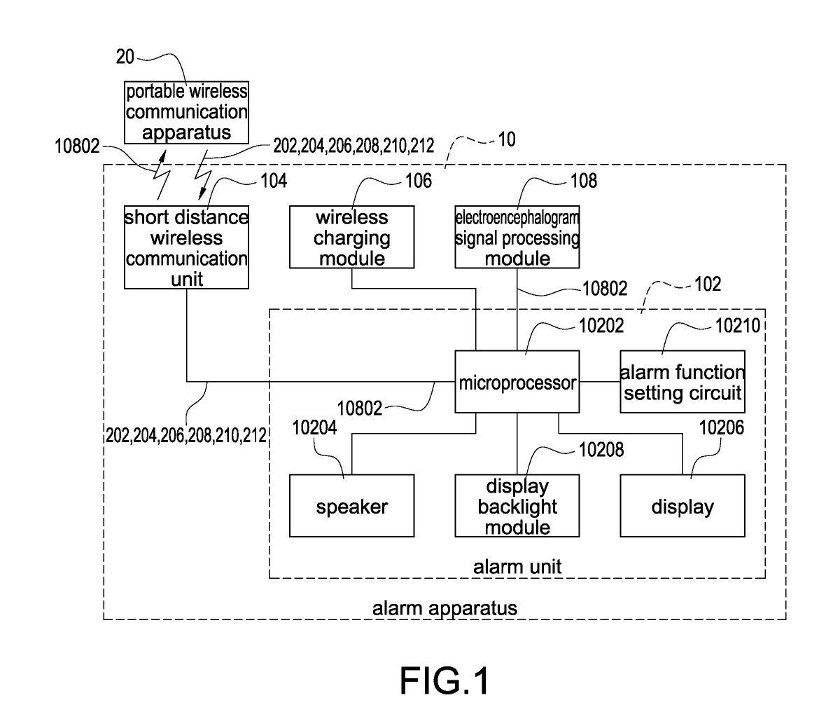

FIG. 1 shows a block diagram of the alarm apparatus of the present invention. An alarm apparatus 10 is applied to a portable wireless communication apparatus 20 (for example, a smart phone). The alarm apparatus 10 comprises an alarm unit 102, a short distance wireless communication unit 104, a wireless charging module 106 and an electroencephalogram signal processing module 108. The alarm unit 102 comprises a microprocessor 10202, a speaker 10204, a display 10206 and a display backlight module 10208.

The short distance wireless communication unit 104 is electrically connected to the alarm unit 102. The wireless charging module 106 is electrically connected to the microprocessor 10202. The electroencephalogram signal processing module 108 is electrically connected to the microprocessor 10202. The microprocessor 10202 is electrically connected to the short distance wireless communication unit 104. The speaker 10204 is electrically connected to the microprocessor 10202. The display 10206 is electrically connected to the microprocessor 10202. The display backlight module 10208 is electrically connected to the microprocessor 10202.

The portable wireless communication apparatus 20 transmits a present time setting signal 202 to the short distance wireless communication unit 104. The short distance wireless communication unit 104 transmits the present time setting signal 202 to the alarm unit 102 after the short distance wireless communication unit 104 receives the present time setting signal 202. The alarm unit 102 sets a present time according to the present time setting signal 202 after the alarm unit 102 receives the present time setting signal 202. For example, the alarm unit 102 sets the present time as 10 o'clock.

Moreover, the portable wireless communication apparatus 20 generates the present time setting signal 202 through the Internet (not shown in FIG. 1) or the satellite (not shown in FIG. 1), so that the present time set by the alarm unit 102 according to the present time setting signal 202 is very accurate.

The short distance wireless communication unit 104 transmits the present time setting signal 202 to the microprocessor 10202 after the short distance wireless communication unit 104 receives the present time setting signal 202. The microprocessor 10202 sets the present time according to the present time setting signal 202 after the microprocessor 10202 receives the present time setting signal 202.

The portable wireless communication apparatus 20 transmits an alarm time setting signal 204 to the short distance wireless communication unit 104. The short distance wireless communication unit 104 transmits the alarm time setting signal 204 to the microprocessor 10202 after the short distance wireless communication unit 104 receives the alarm time setting signal 204. The microprocessor 10202 sets an alarm time according to the alarm time setting signal 204 after the microprocessor 10202 receives the alarm time setting signal 204. For example, the microprocessor 10202 sets the alarm time as 10 o'clock. The microprocessor 10202 is configured to drive the speaker 10204 to play an alarm sound when the alarm time is equal to the present time.

Moreover, the microprocessor 10202 can set a plurality of the alarm times according to a plurality of the alarm time setting signals 204.

The portable wireless communication apparatus 20 transmits an alarm sound pattern setting signal 206 to the short distance wireless communication unit 104. The short distance wireless communication unit 104 transmits the alarm sound pattern setting signal 206 to the microprocessor 10202 after the short distance wireless communication unit 104 receives the alarm sound pattern setting signal 206. The microprocessor 10202 sets a pattern of the alarm sound according to the alarm sound pattern setting signal 206 after the microprocessor 10202 receives the alarm sound pattern setting signal 206.

The portable wireless communication apparatus 20 transmits an alarm sound volume setting signal 208 to the short distance wireless communication unit 104. The short distance wireless communication unit 104 transmits the alarm sound volume setting signal 208 to the microprocessor 10202 after the short distance wireless communication unit 104 receives the alarm sound volume setting signal 208. The microprocessor 10202 sets a volume of the alarm sound according to the alarm sound volume setting signal 208 after the microprocessor 10202 receives the alarm sound volume setting signal 208.

The microprocessor 10202 is configured to drive the display 10206 to display the present time and the alarm time.

The portable wireless communication apparatus 20 transmits a backlight color setting signal 210 to the short distance wireless communication unit 104. The short distance wireless communication unit 104 transmits the backlight color setting signal 210 to the microprocessor 10202 after the short distance wireless communication unit 104 receives the backlight color setting signal 210. The microprocessor 10202 sets a backlight color of the display backlight module 10208 according to the backlight color setting signal 210 after the microprocessor 10202 receives the backlight color setting signal 210. For example, the microprocessor 10202 sets the backlight color as blue.

The portable wireless communication apparatus 20 transmits a backlight brightness setting signal 212 to the short distance wireless communication unit 104. The short distance wireless communication unit 104 transmits the backlight brightness setting signal 212 to the microprocessor 10202 after the short distance wireless communication unit 104 receives the backlight brightness setting signal 212. The microprocessor 10202 sets a backlight brightness of the display backlight module 10208 according to the backlight brightness setting signal 212 after the microprocessor 10202 receives the backlight brightness setting signal 212.

The wireless charging module 106 wirelessly charges the portable wireless communication apparatus 20.

The electroencephalogram signal processing module 108 transmits an electroencephalogram signal 10802 to the microprocessor 10202. The microprocessor 10202 transmits the electroencephalogram signal 10802 to the short distance wireless communication unit 104 after the microprocessor 10202 receives the electroencephalogram signal 10802. The short distance wireless communication unit 104 transmits the electroencephalogram signal 10802 to the portable wireless communication apparatus 20 after the short distance wireless communication unit 104 receives the electroencephalogram signal 10802.

Moreover, the electroencephalogram signal 10802 shows a user's brainwave state (sleeping state). An electroencephalogram signal detection apparatus (not shown in FIG. 1) is touched to the user and is electrically connected to the electroencephalogram signal processing module 108 to generate the electroencephalogram signal 10802. The microprocessor 10202 cancels the alarm time to save power and to avoid disturbing other people if the electroencephalogram signal 10802 shows that the user is not sleeping after the microprocessor 10202 receives the electroencephalogram signal 10802. The microprocessor 10202 keeps the alarm time if the electroencephalogram signal 10802 shows that the user is sleeping.

Moreover, the microprocessor 10202 controls the speaker 10204 to play a music (for example, an aid sleep music or a music which was selected by the user) if the electroencephalogram signal 10802 shows that the user is not sleeping after the microprocessor 10202 receives the electroencephalogram signal 10802. The microprocessor 10202 controls the speaker 10204 not to play the music if the electroencephalogram signal 10802 shows that the user is sleeping.

Moreover, the alarm unit 102 further comprises an alarm function setting circuit 10210 electrically connected to the microprocessor 10202. The alarm function setting circuit 10210 comprises a plurality of physical keys (not shown in FIG. 1) to set the present time, the alarm time, the alarm sound pattern, the alarm sound volume, the backlight color, and the backlight brightness.

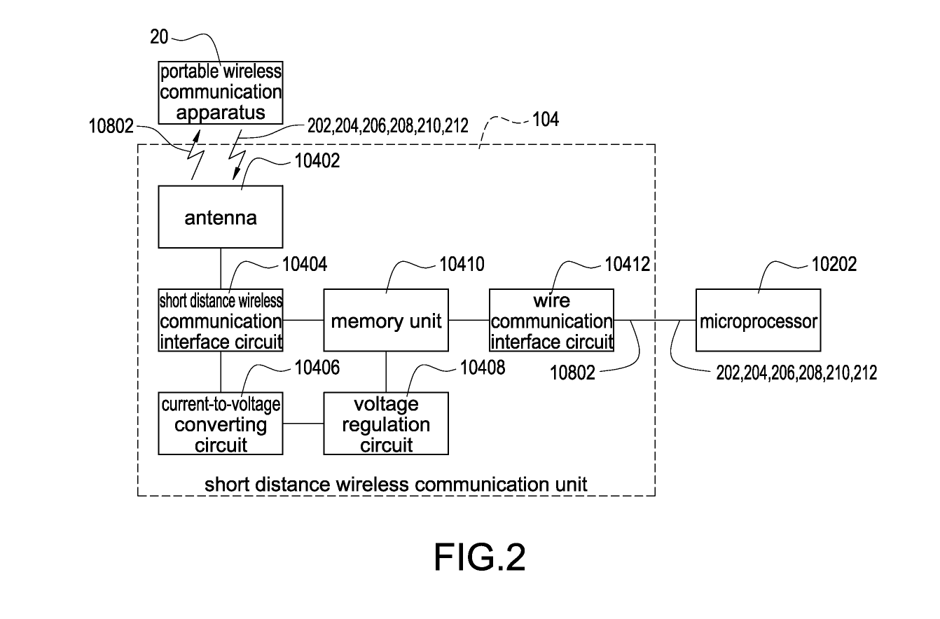

FIG. 2 shows a block diagram of the short distance wireless communication unit of the present invention. The short distance wireless communication unit 104 comprises an antenna 10402, a short distance wireless communication interface circuit 10404, a current-to-voltage converting circuit 10406, a voltage regulation circuit 10408, a memory unit 10410 (for example, a memory) and a wire communication interface circuit 10412.

The short distance wireless communication interface circuit 10404 is electrically connected to the antenna 10402. The current-to-voltage converting circuit 10406 is electrically connected to the short distance wireless communication interface circuit 10404. The voltage regulation circuit 10408 is electrically connected to the current-to-voltage converting circuit 10406. The memory unit 10410 is electrically connected to the short distance wireless communication interface circuit 10404 and the voltage regulation circuit 10408. The wire communication interface circuit 10412 is electrically connected to the memory unit 10410 and the microprocessor 10202.

Moreover, the antenna 10402 induces a wireless signal to generate a current signal. The wireless signal can be the present time setting signal 202, the alarm time setting signal 204, the alarm sound pattern setting signal 206, the alarm sound volume setting signal 208, the backlight color setting signal 210 or the backlight brightness setting signal 212. The antenna 10402 sends the current signal to the short distance wireless communication interface circuit 10404.

The short distance wireless communication interface circuit 10404 sends the current signal to the current-to-voltage converting circuit 10406. The current-to-voltage converting circuit 10406 converts the current signal into a voltage signal. The current-to-voltage converting circuit 10406 sends the voltage signal to the voltage regulation circuit 10408. The voltage regulation circuit 10408 regulates the voltage signal to obtain a driving voltage. The voltage regulation circuit 10408 sends the driving voltage to the memory unit 10410 to drive the memory unit 10410 (namely, the memory unit 10410 is driven by the energy of the wireless signal).

The short distance wireless communication interface circuit 10404 sends the current signal to the memory unit 10410. The memory unit 10410 memorizes a content of the current signal. The microprocessor 10202 fetches the content of the current signal memorized in the memory unit 10410 through the wire communication interface circuit 10412. In another word, the microprocessor 10202 receives the present time setting signal 202, the alarm time setting signal 204, the alarm sound pattern setting signal 206, the alarm sound volume setting signal 208, the backlight color setting signal 210 or the backlight brightness setting signal 212.

The short distance wireless communication interface circuit 10404 is a near field communication interface circuit. The portable wireless communication apparatus 20 comprises a near field communication circuit (not shown in FIG. 1 or FIG. 2). The portable wireless communication apparatus 20 communicates with the alarm apparatus 10 through the near field communication technology.

The portable wireless communication apparatus 20 is installed an APP software to send the present time setting signal 202, the alarm time setting signal 204, the alarm sound pattern setting signal 206, the alarm sound volume setting signal 208, the backlight color setting signal 210 and the backlight brightness setting signal 212 to the alarm apparatus 10. The portable wireless communication apparatus 20 receives the electroencephalogram signal 10802 sent from the alarm apparatus 10.

The present invention comprises following advantages.

1. The present invention can wirelessly set the present time of the alarm, the alarm time of the alarm, the alarm sound pattern of the alarm, the alarm sound volume of the alarm, the backlight color of the display of the alarm, and the backlight brightness of the display of the alarm.

2. The present invention can wirelessly charge the portable wireless communication apparatus.

3. The present invention can be applied to the electroencephalogram.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An alarm apparatus applied to a portable wireless communication apparatus, the alarm apparatus comprising:
an alarm unit; and
a short distance wireless communication unit electrically connected to the alarm unit,
wherein the portable wireless communication apparatus transmits a present time setting signal to the short distance wireless communication unit; the short distance wireless communication unit transmits the present time setting signal to the alarm unit after the short distance wireless communication unit receives the present time setting signal; the alarm unit sets a present time according to the present time setting signal after the alarm unit receives the present time setting signal.

2. The alarm apparatus in claim 1, wherein the alarm unit comprises:
a microprocessor electrically connected to the short distance wireless communication unit,
wherein the short distance wireless communication unit transmits the present time setting signal to the microprocessor after the short distance wireless communication unit receives the present time setting signal; the microprocessor sets the present time according to the present time setting signal after the microprocessor receives the present time setting signal.

3. The alarm apparatus in claim 2, wherein the alarm unit further comprises:
a speaker electrically connected to the microprocessor,
wherein the portable wireless communication apparatus transmits an alarm time setting signal to the short distance wireless communication unit; the short distance wireless communication unit transmits the alarm time setting signal to the microprocessor after the short distance wireless communication unit receives the alarm time setting signal; the microprocessor sets an alarm time according to the alarm time setting signal after the microprocessor receives the alarm time setting signal; the microprocessor is configured to drive the speaker to play an alarm sound when the alarm time is equal to the present time;
wherein the portable wireless communication apparatus transmits an alarm sound pattern setting signal to the short distance wireless communication unit; the short distance wireless communication unit transmits the alarm sound pattern setting signal to the microprocessor after the short distance wireless communication unit receives the alarm sound pattern setting signal; the microprocessor sets a pattern of the alarm sound according to the alarm sound pattern setting signal after the microprocessor receives the alarm sound pattern setting signal;
wherein the portable wireless communication apparatus transmits an alarm sound volume setting signal to the short distance wireless communication unit; the short distance wireless communication unit transmits the alarm sound volume setting signal to the microprocessor after the short distance wireless communication unit receives the alarm sound volume setting signal; the microprocessor sets a volume of the alarm sound according to the alarm sound volume setting signal after the microprocessor receives the alarm sound volume setting signal.

4. The alarm apparatus in claim 3, wherein the alarm unit further comprises:
a display electrically connected to the microprocessor,
wherein the microprocessor is configured to drive the display to display the present time and the alarm time.

5. The alarm apparatus in claim 4, wherein the alarm unit further comprises:
a display backlight module electrically connected to the microprocessor,
wherein the portable wireless communication apparatus transmits a backlight color setting signal to the short distance wireless communication unit; the short distance wireless communication unit transmits the backlight color setting signal to the microprocessor after the short distance wireless communication unit receives the backlight color setting signal; the microprocessor sets a backlight color of the display backlight module according to the backlight color setting signal after the microprocessor receives the backlight color setting signal;
wherein the portable wireless communication apparatus transmits a backlight brightness setting signal to the short distance wireless communication unit; the short distance wireless communication unit transmits the backlight brightness setting signal to the microprocessor after the short distance wireless communication unit receives the backlight brightness setting signal; the microprocessor sets a backlight brightness of the display backlight module according to the backlight brightness setting signal after the microprocessor receives the backlight brightness setting signal.

6. The alarm apparatus in claim 2, further comprising:
a wireless charging module electrically connected to the microprocessor,
wherein the wireless charging module wirelessly charges the portable wireless communication apparatus.

7. The alarm apparatus in claim 2, further comprising:
an electroencephalogram signal processing module electrically connected to the microprocessor,
wherein the electroencephalogram signal processing module transmits an electroencephalogram signal to the microprocessor; the microprocessor transmits the electroencephalogram signal to the short distance wireless communication unit after the microprocessor receives the electroencephalogram signal; the short distance wireless communication unit transmits the electroencephalogram signal to the portable wireless communication apparatus after the short distance wireless communication unit receives the electroencephalogram signal.

8. The alarm apparatus in claim 2, wherein the short distance wireless communication unit comprises:
an antenna; and
a short distance wireless communication interface circuit electrically connected to the antenna.

9. The alarm apparatus in claim 8, wherein the short distance wireless communication unit further comprises:
a current-to-voltage converting circuit electrically connected to the short distance wireless communication interface circuit; and
a voltage regulation circuit electrically connected to the current-to-voltage converting circuit.

10. The alarm apparatus in claim 9, wherein the short distance wireless communication unit further comprises:
a memory unit electrically connected to the short distance wireless communication interface circuit and the voltage regulation circuit; and
a wire communication interface circuit electrically connected to the memory unit and the microprocessor.
